(19) United States
(12) Patent Application Publication
(10) Pub. No.: US 2012/0082435 A1
(43) Pub. Date: Apr. 5, 2012

(54) MOVING IMAGE DISPLAY DEVICE

(76) Inventors: Akira Kimura, Osaka (JP); Hiroshi Ohkubo, Osaka (JP)

(21) Appl. No.: 13/320,797

(22) PCT Filed: May 17, 2010
(86) PCT No.: PCT/JP2010/058259

§ 371 Date: Nov. 16, 2011

(30) Foreign Application Priority Data
May 18, 2009 (JP) 2009-120114

(51) Int. Cl. H04N 5/66; H04N 9/80

(52) U.S. Cl. 386/259; 348/739; 348/E05.133; 386/E05.003

(57) ABSTRACT

When an instruction to start list display of moving images is given, a process is performed to display representative images of respective Video 1 and Video 2. Then, a moving image of Video 1 is decoded, and the moving image of the Video 1 is displayed. Thus, a user can immediately check the contents of multiple moving images to be displayed.

### TECHNICAL FIELD

The present invention relates to a moving image (moving picture) display technique, and relates particularly to a technique of list display of moving image contents in a mobile terminal device having a moving image display function.

### BACKGROUND ART

In recent years, the performances of mobile terminal devices have been improved while being accompanied by enhancement in the number and qualities of contents. As a result, a user can store multiple moving image contents in a mobile terminal device and enjoy these contents by reproducing them. In the invention described in Patent Document 1 listed below, a technique is described in which multiple moving images are decoded and reproduced in parallel. For example, when multiple moving images formed of multiplexed image signals of multiple channels are received, the moving images of the multiple channels can be decoded and reproduced in parallel by performing processing of normally decoding coded data of a predetermined channel while decoding only predetermined frames for the other channels.

### PRIOR ART DOCUMENT

### Patent Document

Patent Document 1: Japanese Patent Application Publication No. 2001-157211 (IMAGE DECODING METHOD, IMAGE DECODING DEVICE, AND RECORDING MEDIUM)

### SUMMARY OF THE INVENTION

### Problem to be Solved by the Invention

FIG. 20 is a view showing an example of a preview display screen of multiple moving images in a device capable of displaying multiple moving image contents (FIG. 20 shows an example in which four moving images are displayed in one screen). Here, a “preview” refers to reduced-size display of a single or multiple frame images or one scene of a moving image extracted from each of the moving image contents, or simple display of the moving image content in reduced size, so that what is included in the image content can be promptly checked. Hereafter in the description, “preview” will be used for such a meaning. As shown in FIG. 20, when an instruction to start the preview is given, a process of decoding a moving image 1 (Video 1) is started with decryption of the moving image, which is shown in the far left section in the drawing. Preview regions for respective multiple moving images (in this example, previews of four moving image files are displayed) are displayed in the display screen, and moving image information (indexes of the moving image contents) of the four moving images is displayed. However, a representative image of only the Video 1 is displayed, and images of moving image 2 (Video 2) and the following ones are not displayed until image processes such as the decryption of the Video 1 are completed. Then, after the decryption process and the like of the Video 1 are completed, the decryption process and decoding process of moving image of the Video 2 are started as shown in the second left section in the drawing. In this state, the representative image of the Video 2 is displayed, but the representative images of Video 3 and the following one are not displayed. Next, after the decryption process and the like of the Video 2 are completed, the decryption process and the decoding process of moving image of the Video 3 are started as shown in the third left section in the drawing. At this point, the representative image of the Video 3 is displayed, but the representative image of a Video 4 is not displayed yet. Subsequently, after the decryption process and the like of the Video 3 are completed, the decoding process of moving image of Video 4 is started with the decryption of the encoding as shown in the fourth left section in the drawing. At this point, all (four) the preview images displayed in the list are displayed for the first time, and a long time is required to display the previews of contents of all the moving images. Accordingly, a long time is required for a user to know what kinds of moving images can be displayed. This problem is becoming more serious.

An object of the present invention is to provide a technique of allowing a user to know outlines of multiple moving images in a shorter time.

### Means for Solving Problem

The present invention provides a moving image display device comprising: a process integrated-control part configured to perform integrated control of processes of reproducing a plurality of moving images in parallel and displaying the moving images on a display part; and an interface part, a storage part, a representative image acquisition part, and a display image processor which operate based on instructions from the process integrated-control part, the interface part configured to acquire moving image data, the storage part configured to store first moving image data and second moving image data which are pieces of the moving image data acquired by the interface part, the representative image acquisition part configured to extract or create still image data from the moving image data stored in the storage part, the display image processor configure to, upon receiving an instruction to perform list display of the first moving image data and the second moving image data, cause the display part to display first still image data extracted or created from the first moving image data and second still image data extracted or created from the second moving image data, and thereafter to display a moving image of the first moving image data.

In the moving image display device, the first still image data is preferably data in one frame in the first moving image data, and in displaying the moving image of the first moving image data, the display image processor preferably causes the moving image to be displayed from the one frame.

In the moving image display device, the first still image data is preferably data in one frame in the first moving image data, and in displaying the moving image of the first moving image data, the display image processor preferably causes the moving image to be displayed from a frame subsequent to the one frame.

In the moving image display device, the representative image acquisition part preferably extracts or creates a plurality of pieces of still image data from the moving image data, and in displaying the first still image data or the second still image data on the display part, the display image processor preferably causes the plurality of pieces of still image data to be sequentially displayed.

The moving image display device further comprises a preview reproduction processor configured to perform an image process of creating preview data for preview display of each of the moving images on the basis of the moving image data stored in the storage part, and in the moving image display device, upon receiving the preview data processed by the preview reproduction processor, the display image processor preferably substitutes the still image data of the corresponding moving image with the preview data.

In the moving image display device, each piece of the still image data is preferably of a still image representing the corresponding moving image or is preferably of an image of the moving image which requires no reference to any preceding or subsequent frame.

In addition, the present invention provides a moving image display method for reproducing a plurality of moving images in parallel and displaying the moving images on a display part, the method comprising: a step of acquiring moving image data; a step of storing first moving image data and second moving image data which are pieces of the acquired moving image data; a representative image acquisition step of extracting or creating still image data from the stored moving image data; a display image processing step of, when an instruction to perform list display of the first moving image data and the second moving image data is given, causing the display part to display first still image data extracted or created from the first moving image data and second still image data extracted or created from the second moving image data, and thereafter to display a moving image of the first moving image data.

Moreover, the present invention provides a program causing a computer to execute the moving image display method described above.

The description incorporates the contents described in the description and/or the drawings of Japanese Patent Application No. 2009-120114, which is the base of the priority of the present application.

### Effect of the Invention

Contents of multiple moving images to be displayed can be known in a shorter time.

### BRIEF DESCRIPTION OF THE DRAWINGS

FIG. 1 is a view showing an example of an exterior configuration of a mobile phone terminal of an embodiment of the present invention which has a moving image displaying function.

Part (a) of FIG. 2 is a view showing an example of a utilization mode of the mobile phone terminal, and Part (b) of FIG. 2 is a view showing a configuration example of a file group stored in an external storage unit.

FIG. 3 is a functional block diagram showing a configuration example of the mobile phone terminal A of the embodiment.

FIG. 4 is a chart showing a flow of a process of a process integrated-control part of the mobile phone terminal of the embodiment.

FIG. 5 is a chart showing a flow of a process of a representative image acquisition part (moving image identification data acquisition part) of the mobile phone terminal of the embodiment.

FIG. 6A is a view showing a data configuration in the external storage unit.

FIG. 6B is a view showing an example of a process of decryption of encrypted data.

FIG. 6C is a view showing how a PES packet is acquired.

FIG. 6D is a view showing how a PES data portion is acquired.

FIG. 6E is a view showing how representative (head) image data is acquired.

FIG. 6F is a chart showing a flow of a representative (head) image data acquisition process.

FIG. 6G is a chart showing the flow of the representative (head) image data acquisition process.

FIG. 6H is a chart showing the flow of the representative (head) image data acquisition process.

FIG. 7 is a chart showing a flow of a process in a moving image data acquisition part.

FIG. 8 is a chart showing a flow of a process in a preview reproduction processor.

FIG. 9 is a view showing how a process is specifically performed in the external storage unit.

FIG. 10 is a view showing how a process is specifically performed in a main memory unit (memory).

FIG. 11 is a view showing how the process is specifically performed in the moving image data acquisition part.

FIG. 12 is a view showing how the process is specifically performed in the representative image acquisition part (moving image identification data acquisition part).

FIG. 13 is a view showing how the process is specifically performed in the preview reproduction processor.

FIG. 14 is a view showing how a process is specifically performed in a display image processor.

FIG. 15 is a view showing a configuration example of general MPEG2 TS data.

FIG. 16 is a view showing a storage example of moving image data.

FIG. 17 is a view showing an example of encryption of data.

FIG. 18 is a view showing a flow of a data encryption process.

FIG. 19 is a view showing an example of a preview display screen of multiple moving images in the device of the embodiment which is capable of reproducing multiple moving image contents.

FIG. 20 is a view showing an example of a preview display screen of multiple moving images in a device capable of reproducing multiple moving image contents.

### EXPLANATION OF THE REFERENCE NUMERALS

A mobile phone terminal (moving image display device)
3 display unit
3a touch panel
7 key input unit
11 external storage unit
21 input unit interface
23 process integrated-control part
25 memory (DRAM)
27 moving image data acquisition part
31 representative image acquisition part (moving image identification data acquisition part)
33 moving image decoding processor
35 preview reproduction processor
37 display image processor
41 storage unit I/O interface
45 decryption processor

### MODES FOR CARRYING OUT THE INVENTION

In the description, a moving image refers to an image reproduced in accordance with a reproduction timing of moving image data if moving image data includes the reproduction timing, and to an image reproduced by updating frames at certain time intervals if the reproduction timing included in the moving image data is not used or if the moving image data includes no reproduction timing. A representative image is an image representing the moving image data, and is a still image extracted or created from the moving image data. The representative image includes, for example, a still image created by cutting out part of the moving image, data corresponding to one frame in the moving image which requires no reference to another preceding or subsequent frame, and the like. Moreover, the representative image is treated as a still image in this description. Thus, even if the representative image is extracted from any portion in a moving image file, the representative image is independent of the reproduction timing included in that moving image file. Accordingly, the same frame (still image) continues to be displayed even if the time elapses. A process of extracting the representative image from the moving image data is a process which can be performed faster than a process of displaying the moving image or of displaying a preview of the moving image. This is due to the following reason. In the process of extracting the representative image, one portion of the moving image data which includes data corresponding to one frame is to be processed. Hence, the length of the moving image data to be read to a memory is far smaller than those in the process of displaying the moving image or of displaying the preview, in which the entire moving image data is to be processed. Note that, a case of displaying the moving image after reducing its size or after extracting part of the moving image will be referred to as preview display. A case of displaying the moving image without performing such processes will be simply referred to as display of the moving image.

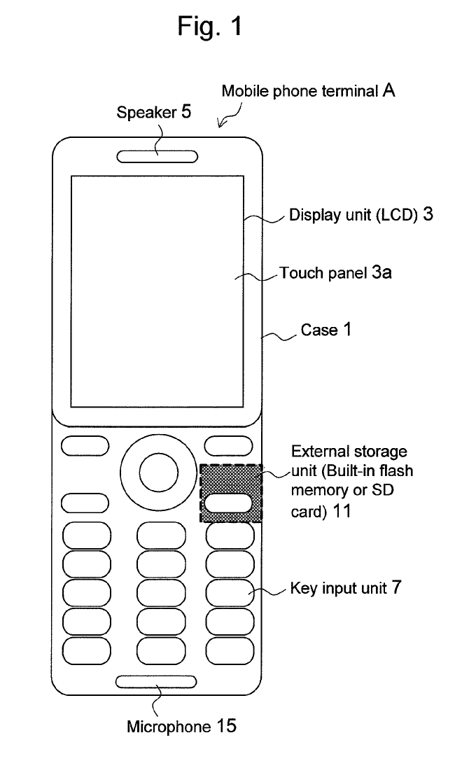

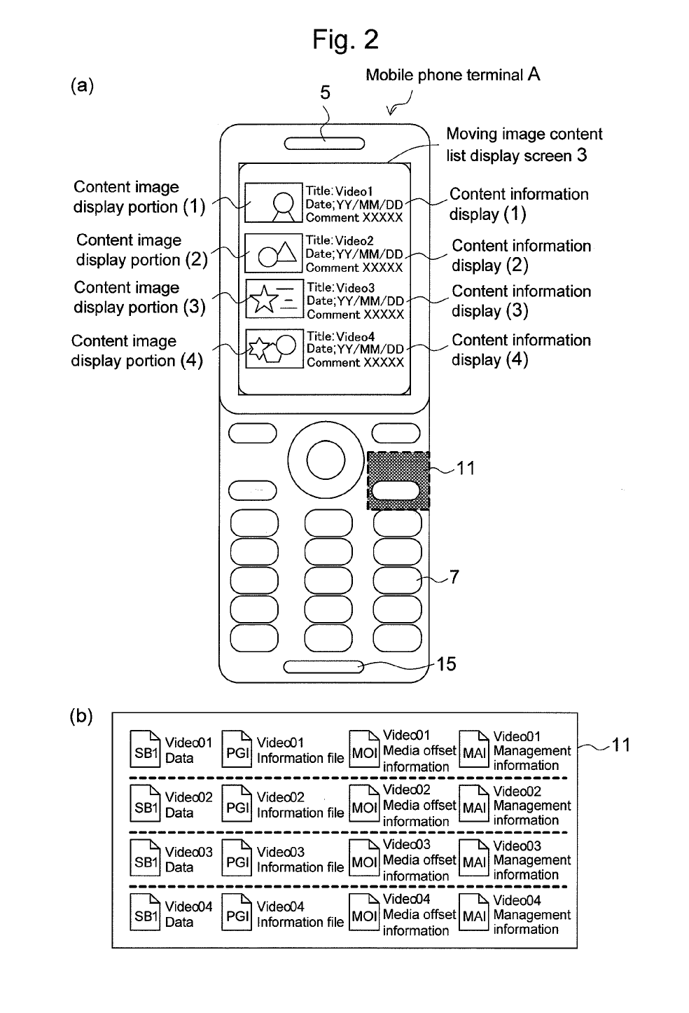

Referring to the drawings, descriptions will be given below while using a general mobile phone terminal as an example of a moving image display device of an embodiment of the present invention. FIG. 1 is a view showing an example of an exterior configuration of a mobile phone terminal A. The mobile phone terminal A includes a case 1, an LCD display unit 3, a speaker 5, a key input unit 7, an external storage unit 11 (a built-in flash memory, a removable memory card, or the like), and a microphone 15. The display unit 3 may include a touch panel 3a. The external storage unit 11 can store multiple moving image contents. Descriptions will be given below on the assumption that multiple moving image contents are stored in the external storage unit 11. The moving image may be one captured by an attached camera, which is not illustrated, or one received by streaming.

Part (a) of FIG. 2 is a view showing an example of a utilization mode of the mobile phone terminal A, and shows a state where four indexes of the respective moving image contents are displayed in the LCD display unit 3 as an example of a menu display of the moving image contents. Content image displays (1) to (4) are a moving image content list display screen in which the representative images of respective video contents (Videos 1 to 4) stored in the external storage unit 11 are displayed. For example, the first frame image of each of the video contents is displayed as the representative image, immediately after the moving image content list display screen is displayed (for example, immediately after an instruction is given of the preview display of the multiple moving image contents). Moreover, a piece of Video information such as a title, creation date and time, and other texts of each of the video contents (Video X) may be arbitrarily displayed as a contents information display, with the corresponding representative image. Each of these pieces of Video information is written in an information file generated for each of the video contents.

As the time elapses, the preview display of “moving image” of each of the video contents is started one by one in a display region of the corresponding representative image. This allows detailed information of the moving images to be known visually.

Part (b) of FIG. 2 is a view showing an example of a file group stored in the external storage unit 11. As shown in Part (b) of FIG. 2, a Video file, a Video information file, a Video media offset information file, and a Video management information file are stored as a set. In this example, the moving image contents stored in the SD-Video format are given as an example. In the SD-Video format, each of the moving image contents is stored in four files of a SB1 file, a PGI file, an MOI file, and an MAI file. Among file names written in respective file figures in Part (b) of FIG. 2, the SB1 files are each a data sequence (encrypted) of encoded moving image and audio. The MOI (Media Object Information) files are each a file storing, in offset information, a position at which media data in the corresponding SB1 file is stored. The PGI files are each a file storing the corresponding title, creation date and time, and the like. The MAI files are each a file for management. The SB1 files and the MOI files relate to the embodiment. Note that, the video contents are each formed of video data encoded in MPEG4/AVC and audio data encoded in MPEG4-Audio (AAC). Moreover, in a state where these video contents are stored in the storage unit, the video contents are generally encrypted to protect the contents. However, the video contents are not limited to such video contents.

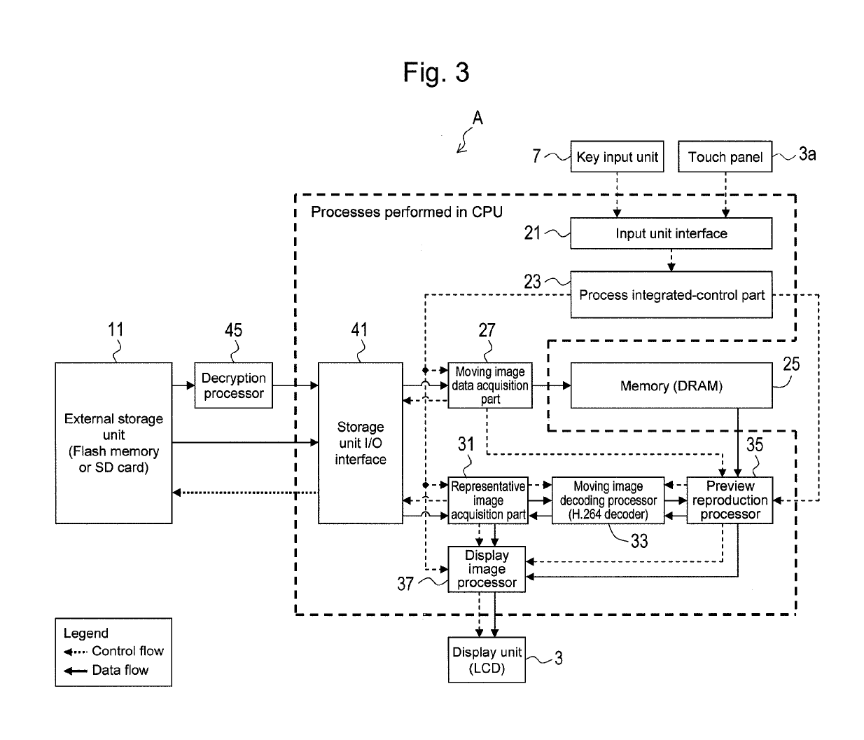

FIG. 3 is a functional block diagram showing a configuration example of the mobile phone terminal A of the embodiment. The mobile phone terminal A shown in FIG. 3 includes the display unit 3 including the function of the touch panel 3a, the key input unit 7 being an input device operated by a user to start list display of multiple moving images, the external storage unit 11 being a flash memory or a memory card in which contents are stored, a decryption processor 45 decrypting the encrypted video contents stored in the external storage unit 11, and a CPU (inside of the broken line corresponds to processors implemented in the CPU). The following configurations are included in the CPU.
a) Process integrated-control part 23: The process integrated-control part 23 performs integrated control of a series of processes for performing list display of the previews of multiple moving images.
b) Storage unit 110 interface 41: The storage unit I/O interface 41 is an interface managing reading and writing of data from and to the external storage unit 11. The storage unit I/O interface 41 reads requested data from the external storage unit 11 and returns the data in response to a data read request from a representative image data acquisition part or a moving image data acquisition part described below. If the requested data is encrypted data, the storage unit I/O interface 41 decrypts the encryption and then returns the data.
c) Memory (DRAM) 25: The memory 25 is a memory widely and generally used, and is a type of DRAM (Dynamic Random Access Memory).
d) Moving image data acquisition part 27: The moving image data acquisition part 27 performs a process of reading data of a certain size (720 kB, for example) from the moving image content data stored in the external storage unit 11, and then writing the data into the memory (DRAM) 25.
e) Representative image acquisition part 31 (moving image identification data acquisition part): The representative image acquisition part 31 performs a process of reading data including a head image of each moving image from the moving image content data stored in the external storage unit 11, or the like and then decoding moving image data. Alternatively, the representative image acquisition part 31 performs a process of acquiring data used for identification of the moving image content data from the Video information described above.
f) Preview reproduction processor 35: The preview reproduction processor 35 reads the moving image content data written into the memory, sequentially decodes pieces of the moving image data, and sends the pieces of the data to a display image processor.
g) Moving image decoding processor 33: The moving image decoding processor 33 is a type of an H.264 decoder generally used.
h) Display image processor 37: The display image processor 37 performs a process of synthesizing the moving image data received from the representative image acquisition part 31 and the moving image data received from preview reproduction processor 35, and updates the display screen.
i) Display unit (LCD) 3: The display unit 3 is a display part such as a liquid crystal panel generally and widely used.
j) Input unit interface 21: The input unit interface 21 receives inputs from the touch panel 3a and the key input unit 7, and notifies the process integrated-control part 23 of the inputs.

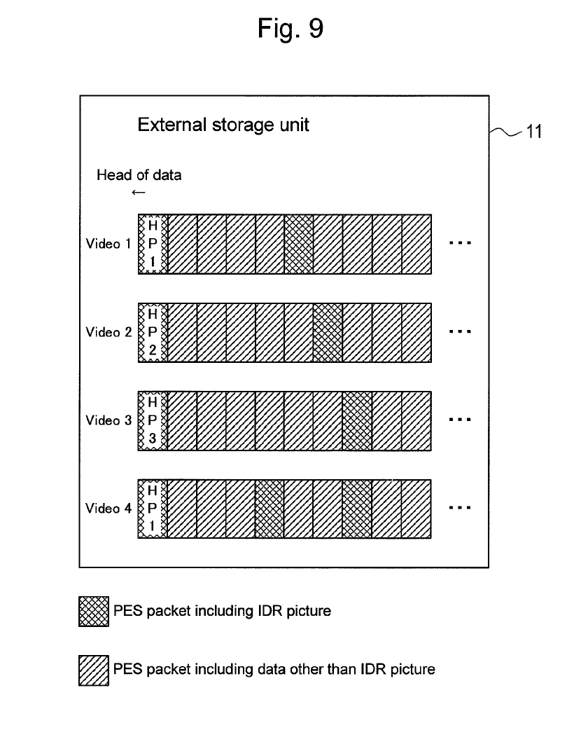

FIGS. 9 to 14 are views specifically showing how processes are performed in the respective processors. As shown in FIG. 9, in each of the data sequences of Videos 1 to 4 in the external storage unit 11, a PES packet including an IDR picture and disposed at a head shown in HPI, a PES packet including an IDR picture and disposed at a position away from the head, and PES packets including data other than the IDR picture are disposed. The moving image content data stored in the external storage unit is generally encrypted to protect the contents.

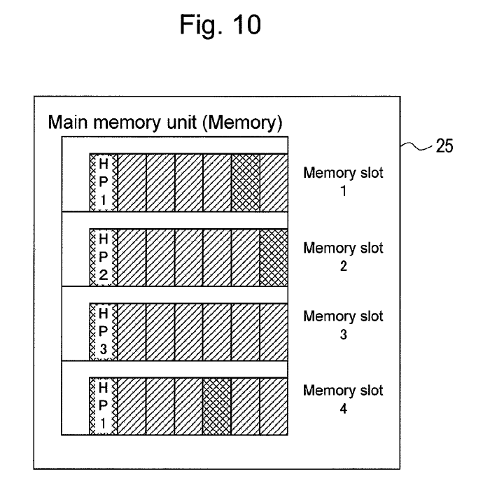

The process integrated-control part 23 first instructs the representative image acquisition part 31 to acquire a data block of each head which includes the image data to be the representative image. After completing the acquisition of all N representative images, the process integrated-control part 23 instructs the moving image data acquisition part 27 to acquire as much moving image data blocks as possible which can be stored in each of memory slots (FIG. 10).

The representative image acquisition part 31 acquires the data block including the IDR picture from the head of each sequence of data in accordance with the instruction from the process integrated-control part 23. This data block is the PES packet (HPI) including the IDR picture which is shown in FIG. 9. Since data acquired herein is coded, the moving image decoding processor 33 is used to decode the moving image data. The process integrated-control part 23 instructs the display unit 3 to output a decoded image as the representative image.

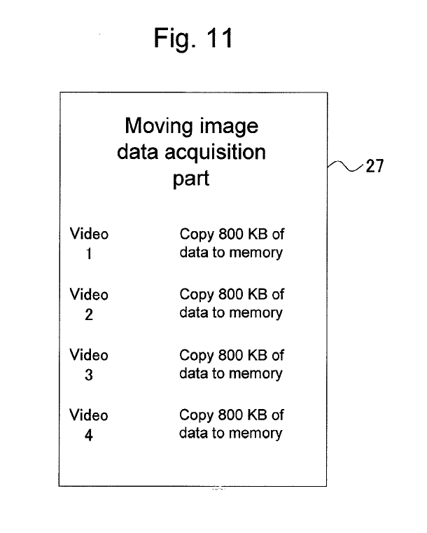

As shown in FIG. 10, the main memory unit (memory) 25 is a RAM (Random Access Memory). Technically, the RAM 25 is used by all of the processors. However, only the part related to the point of the invention will be described. The memory 25 is provided with multiple memory slots, and pieces of data corresponding to those in FIG. 9 are stored in the respective memory slots. As shown in FIG. 11, the moving image data acquisition part 27 acquires pieces of Video data from the external storage unit 11, and copies 800 kB of each piece of Video data to the memory 25 in the case of preview display. This process by the moving image data acquisition part 27 causes the multiple PES packets of each Video shown in FIG. 9 to be stored in the corresponding memory slot as shown in FIG. 10. Note that, only data corresponding to about 10 to 15 seconds, for example, is required in order to perform the preview display. This brings about such effects that the utilization amount of the memory is reduced and the preview processing is increased in speed.

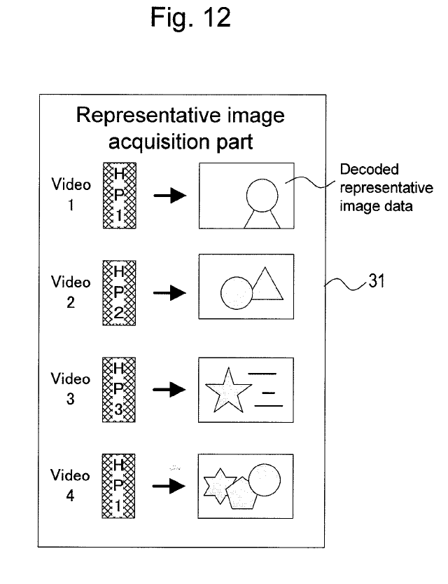

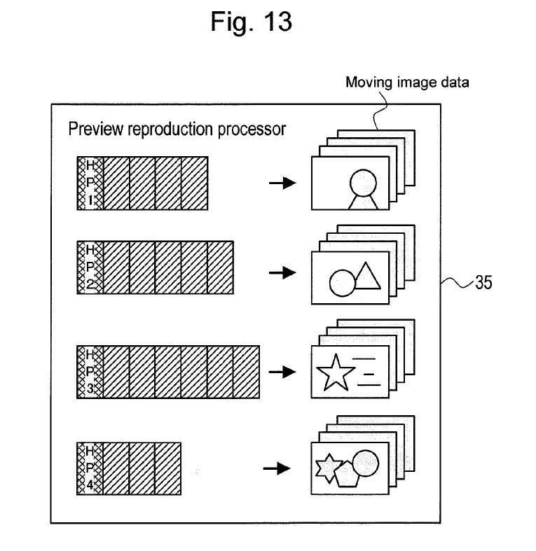

As shown in FIG. 12, the representative image acquisition part 31 extracts the representative image data decoded from the HPI being the PES packet including an IDR picture, for each piece of the Video data. As shown in FIG. 13, the preview reproduction processor 35 operates in parallel with the representative image acquisition part 31. The preview reproduction processor 35 monitors the memory slots (FIG. 10), and waits for the moving image data to be stored therein. Upon confirming that the moving image data is stored in the memory slots, the preview reproduction processor 35 reads the data and starts decoding of the moving image data by utilizing the moving image decoding processor 33. The decoded moving image data is sent to the display unit 3 together with a content number, and an instruction is given to update the display image from the representative image to a corresponding moving image. These processes are performed for all of the memory slots, and a process of switching of the memory slots to be processed is performed sequentially in a time sharing manner.

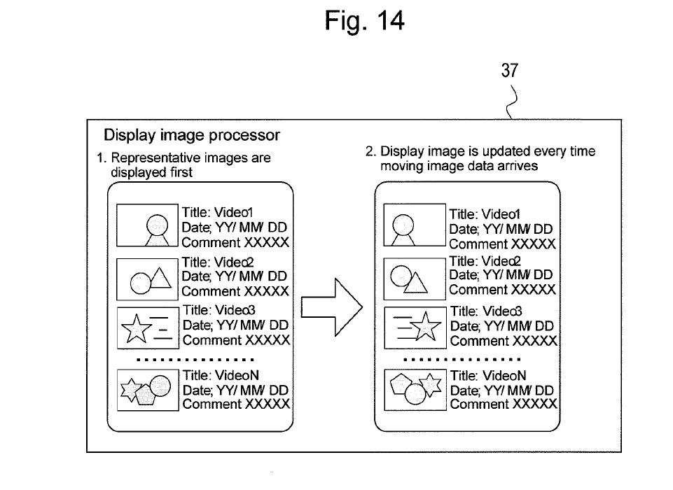

As shown in FIG. 14, the display image processor 37 first causes the representative image to be displayed, and, upon receiving the moving image data, performs a process of update in which the representative image display is substituted with the moving image display. For example, when the preview display is performed as the moving image display, the process of update in which the representative image display is substituted with the preview display is performed every time when preview data is sent from the preview reproduction processor 35. This process allows the display of the representative image and the process of substitution with the preview display to be performed smoothly.

Note that, a control flow refers to a flow in which an arrow source block instructs an arrow destination block to perform a process, a flow in which the arrow source block requests the arrow destination block for data, and the like. A data flow refers to a flow of data, such as the moving image data, from the arrow source block to the arrow destination block.

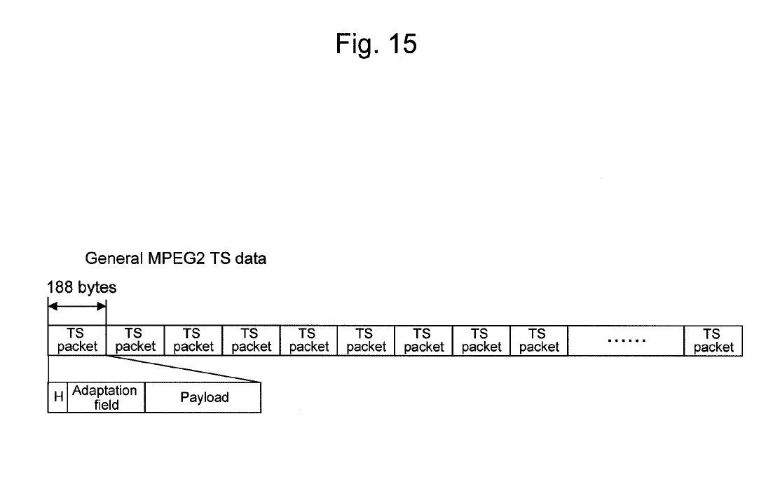

Next, a data format of the video contents will be described with reference to FIGS. 15 to 17. The data format to be used is MPEG2 TS (ISO/IEC) 13818-1. Note that, as shown in FIG. 15, in MPEG2 TS, a file is created in which coded video data and audio data are stored as a data stream formed of data blocks each having a fixed length (188 bytes) which are called TS packets. H (header field) includes a packet identifier and the like. An adaptation field includes time information used as a reference for the reproduction of moving image data and stuffing data (redundant data for length adjustment). The video data, the audio data, and the like are stored in a payload.

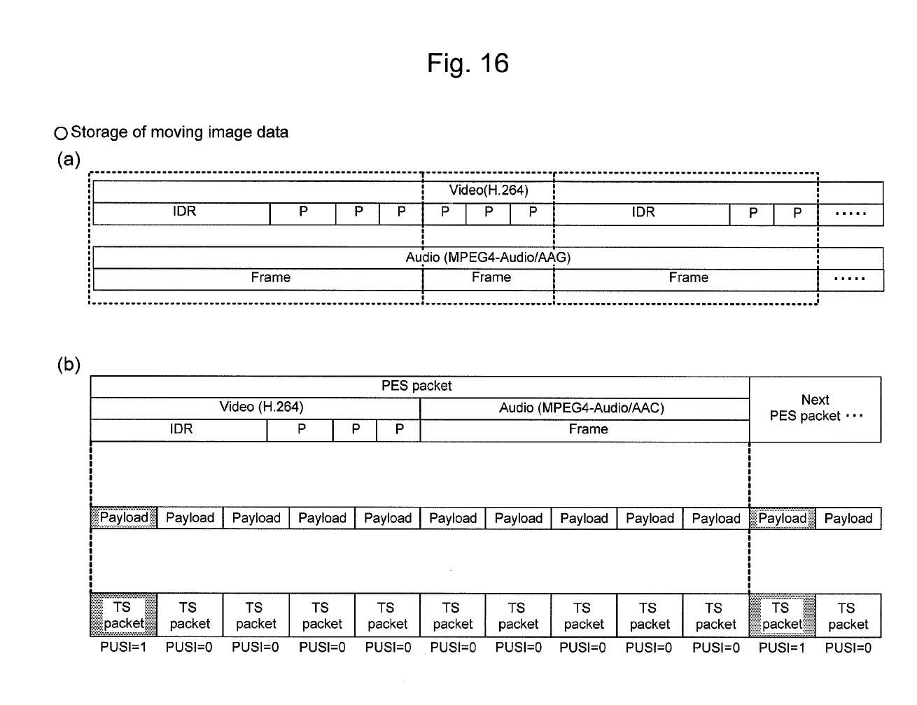

FIG. 16 is a view showing a storage example of the moving image data. Part (a) of FIG. 16 is a view showing an example in which the moving image data is stored in MPEG2 TS. The moving image is formed of IDR, P, P, and so on, and the audio data is formed of Frames. These moving image and audio data are arranged in this order on a time axis. A region surrounded by a frame of a broken line is a portion requiring synchronization.

As shown in an upper portion of Part (b) of FIG. 16, the image and audio which need to be synchronized are grouped into a single PES packet. If the PES packet includes the IDR picture data, the IDR picture data is always included at the head of the PES packet. As shown below the upper portion of Part (b) of FIG. 16, the PES packet is divided into pieces of data each having a size of 184 bytes or smaller, to fit into TS packets.

A lower portion of Part (b) of FIG. 16 is a view showing how the TS packets are formed by adding a header of 4 bytes and an adaptation field to each of divided payloads. When the header is added, the TS packet storing head data of the PES packet is set with a flag indicating that the TS packet is the head (PUSI=1). The subsequent divided pieces of data are each set with PUSI=0, and also include reference time information used to reproduce the stream. The flag of PUSI=1 is set at the head at a position where the next synchronization is required. Note that, these data formats are ones according to MPEG2 TS (ISO/IEC 13818-1) and the specifications for one-seg, and are given as examples.

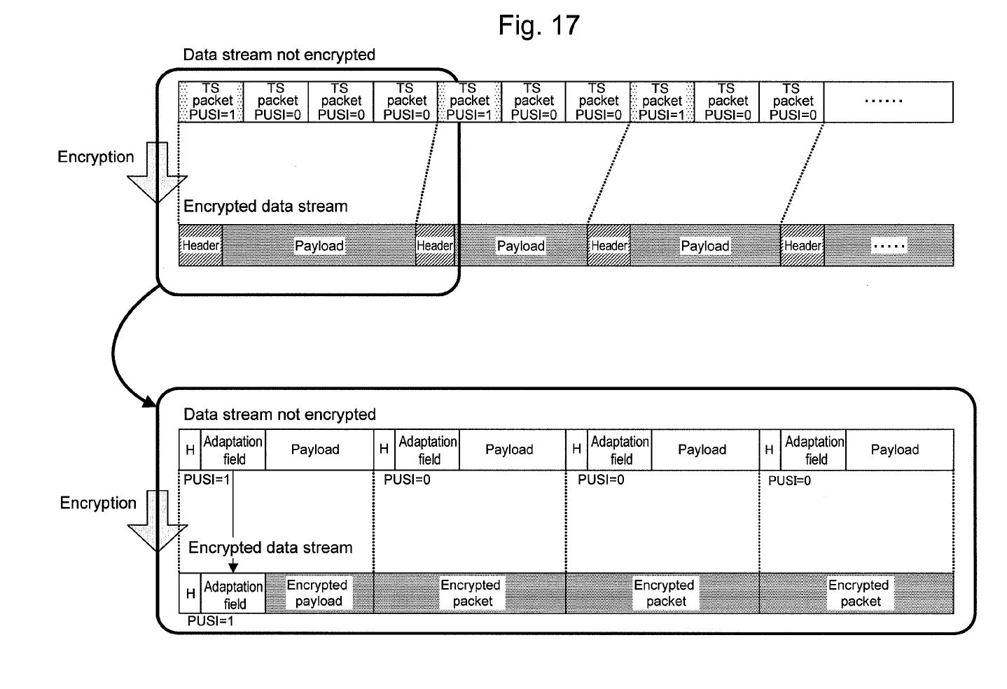

Next, descriptions are given of encryption of data, although this process is not always necessary in the invention. FIG. 17 is a view showing an outline of the encryption process to be described in the embodiment below. In an upper portion of FIG. 17, a data configuration of the moving image data which is not encrypted is shown, and the data is formed of many TS packets. As shown in the drawing therebelow, when this data is encrypted, the data is formed of repeatedly arranged groups each including the header and the stream, and the encryption is performed in units of PES packets of video and audio (each PES packet can be judged as a portion from one packet of PUSI=1 to a packet previous to the next packet of PUSI=1).

A detailed configuration of a region surrounded by a bold line in an upper half of the drawing will be shown in the lower half of the drawing. The moving image data which is not encrypted is formed of repeatedly arranged groups each including the H (header), the adaptation field, and the payload. When the data is encrypted, the data is formed of a group including the H, the adaptation field, and the encrypted payloads. The header and the adaptation field of the packet of PUSI=1 are not encrypted (this adaptation field includes the time information used as a reference for the reproduction of stream). This is used to reproduce the stream.

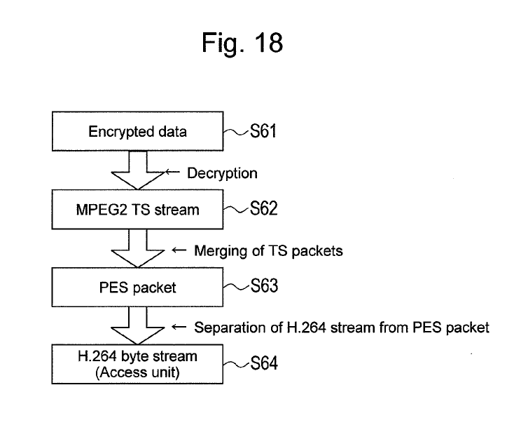

FIG. 18 is a flowchart showing a simple flow from the aforementioned encryption of contents to acquisition of moving image stream. As shown in FIG. 18, the encrypted data is prepared first (step S61), and is then decrypted into an MPEG2 TS stream (step S62). The decryption is performed by the decryption processor 45, and the acquired MPEG2 TS stream is sent to the moving image data acquisition part 27 and the representative image acquisition part 31 via the storage unit I/O interface 41. Note that, the moving image data acquisition part 27 writes the received MPEG2 TS data to the memory (DRAM) 25 without making any change. Next, the representative image acquisition part 31 and the preview reproduction processor 35 merge the TS packets in the acquired MPEG2 TS packets into PES packets (step S63). Then, the representative image acquisition part 31 and the preview reproduction processor 35 separate an H.264 stream from the obtained PES packets, and set the H.264 stream as an H.264 byte stream (access unit) (step S64).

The moving image decoding processor (H.264 decoder) is used to obtain the representative image and the moving image from the H.264 byte stream (access unit) obtained in the end.

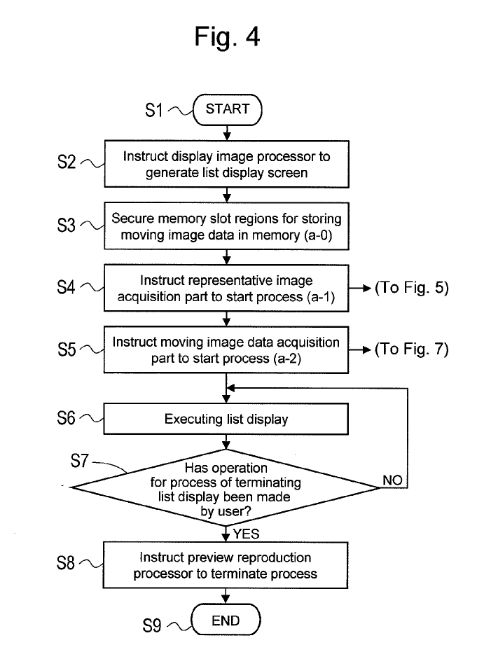

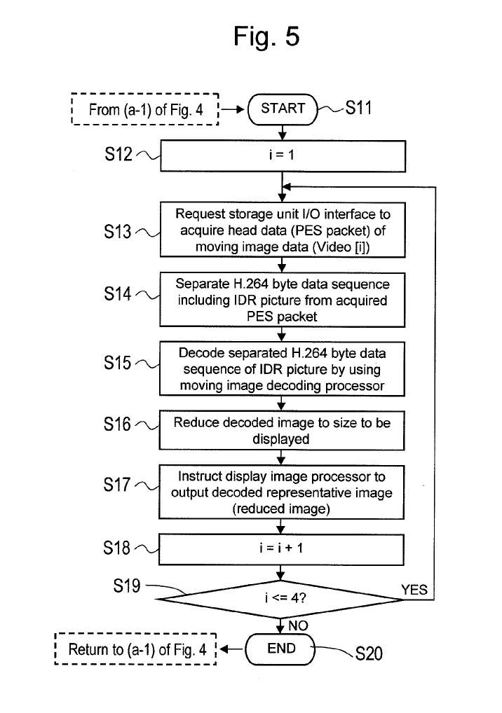

Details of the processes of the embodiment will be described below. FIG. 4 is a chart showing a flow of a process in the process integrated-control part 23. When the user operates the key input unit 7 or the touch panel 3a to give an instruction to start the list display process of multiple moving images, the process of the process integrated-control part 23 is started (step S1: START). Next, in step S2, the process integrated-control part 23 instructs the display image processor 37 to generate a list display screen. In step S3, memory slot regions (see FIG. 10) for storing the moving image data in the memory 25 are secured (a-0). In step S4, the process integrated-control part 23 instructs the representative image acquisition part 31 (see FIG. 12) to start a process (a-1). Note that, the representative images of all the respective moving image contents are displayed in the list display at the time point when the process based on (a-1) is completed. In step S5, the process integrated-control part 23 instructs the moving image data acquisition part 27 (see FIG. 11) to start a process (a-2). All of the moving image contents displayed in the list display are in a reproducible state (capable of preview display) at the time point when the process based on the instruction of (a-2) is completed. In step S6, the list display is executed. In step S7, the process integrated-control part 23 waits until receiving an operation for a termination process of the list display from the user. While the list display is executed, a preview display part operates continuously to repeat the reproduction of moving images. When the operation is detected (YES), the process integrated-control part 23 instructs the preview reproduction processor to terminate the process, and the process is terminated in step S9.

FIG. 5 is a chart showing a flow of a process of the representative image acquisition part 31, and the process is started in response to an instruction from the process integrated-control part 23 (step S11: from a-1 of FIG. 4). Next, in step S12, i (the order of displaying the representative image) is set to i=1.

In step S13, the representative image acquisition part 31 requests the storage unit I/O interface 41 to acquire the head data (PES packet) of the moving image data (Video [i]. In the embodiment, the moving image data corresponding to the video content Video 1 (first moving image data) is assumed to be i=1 (Video [1]), and the moving image data corresponding to the video content Video 2 (second moving image data) is assumed to be i=2 (Video [2])). As shown in FIG. 16, the head data (PES packet) of each piece of the moving image data includes IDR picture data. Thus, acquisition of data corresponding to one PES packet at the head is requested. In step S14, the H.264 byte data sequence including the IDR picture is separated from the acquired PES packet. Here, the H.264 byte stream to be the IDR picture is separated from the PES packet. The separation can be made possible by analyzing the access unit of H.264. Next, in step S15, the separated H.264 byte data sequence of the IDR picture is decoded by using the moving image decoding processor 33. Image data of YUV420 format (one piece of data) is acquired from the IDR picture data acquired by performing the procedures described above, by using the moving image decoding processor 33. Note that, the IDR picture data is closed in one frame (requires no reference to any preceding or subsequent frame). In step S16, the decoded image is reduced to a size to be displayed. Since the image size needs to be reduced in the list display, a reduction process is performed in this step.

In step S17, the representative image acquisition part 31 instructs the display image processor 37 to output the decoded representative image (reduced image). To be specific, the reduced image is written to a video buffer of the display image processor 37, and an instruction for re-rendering is given. The representative image acquisition part 31 sets i=i+1 in step S18, and judges whether i≦4 or not in step S19. If NO, the process is terminated in step S20, and the flow returns to (a-1). At this point, a still image (first still image data) which is an image created by reducing an image extracted from the Video [1] (first moving image data) and a still image (second still image data) which is an image created by reducing an image extracted from the Video [2] (second moving image data) are displayed in the display unit 3. If YES, the flow returns to step S13, and the process is repeated. After these processes are completed, the displayed representative image data (including the first still image data and the second still image data) remains still until a moving image reproduction process (including a reproduction process of the first moving image data) is performed by the preview reproduction processor described later. In the embodiment, the decoding is performed in units of PES packets (in accordance with the standards of one-seg). However, the invention is applicable to other methods, as long as the decoding is performed in units based on H.264 access units (for example, the invention is applicable to the MP4 file format).

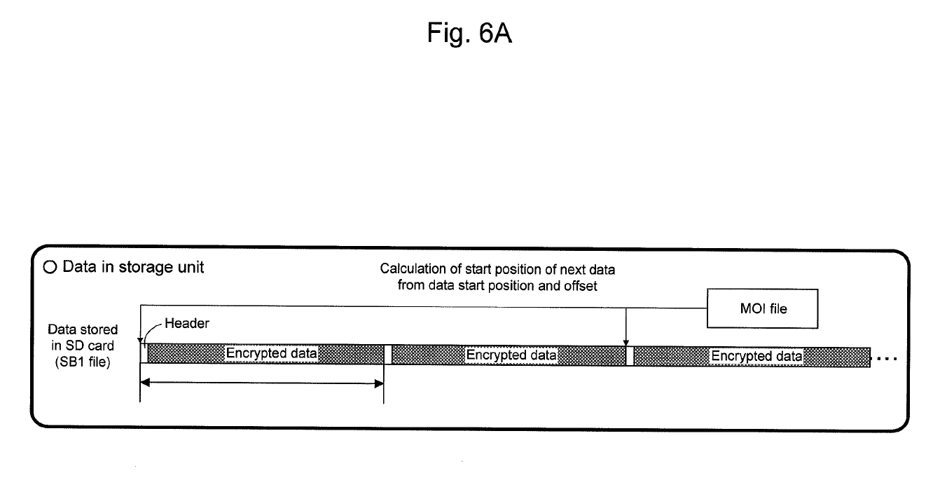

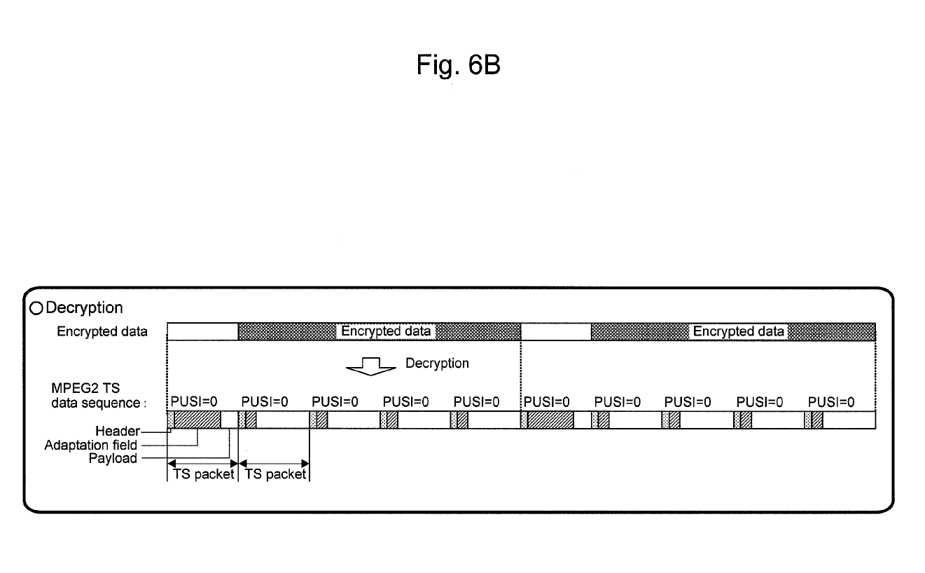

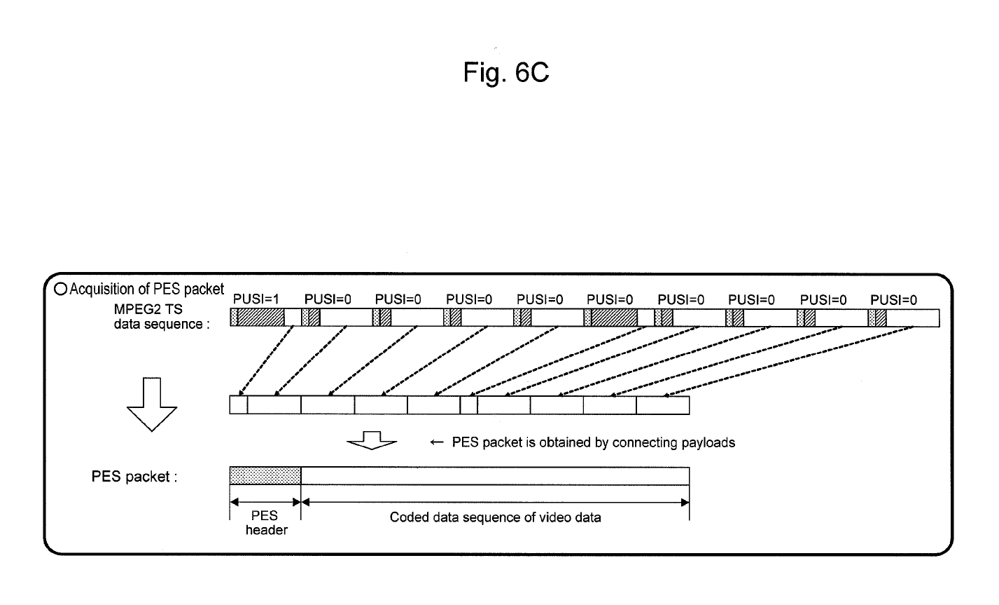

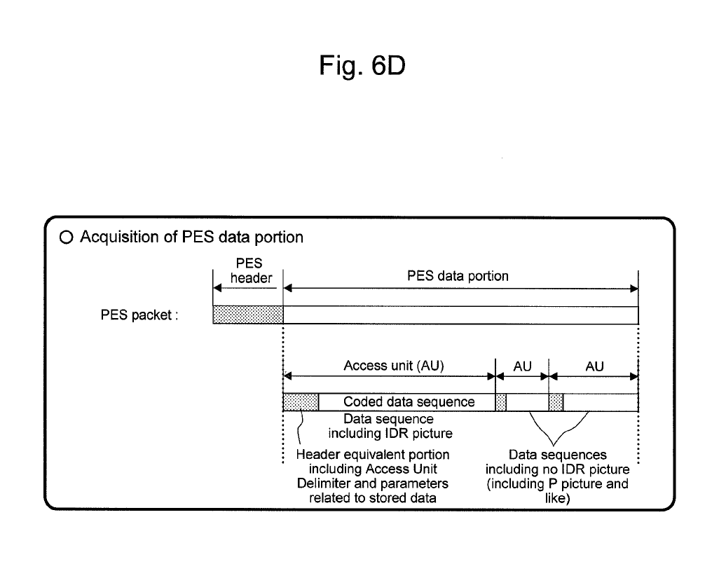

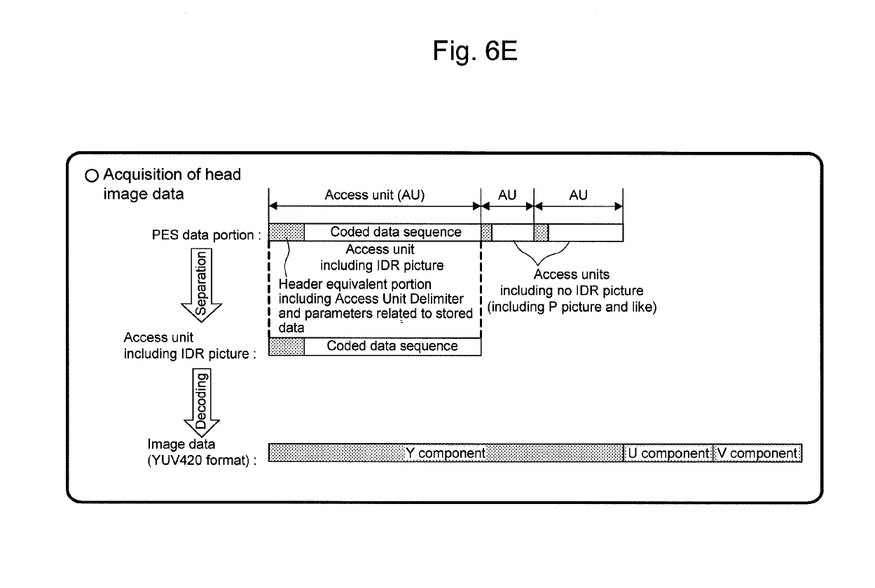

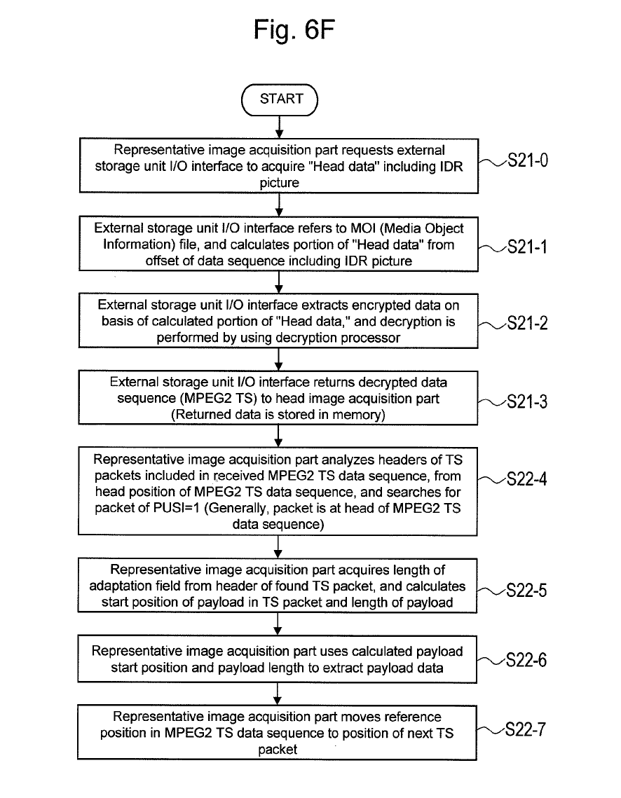

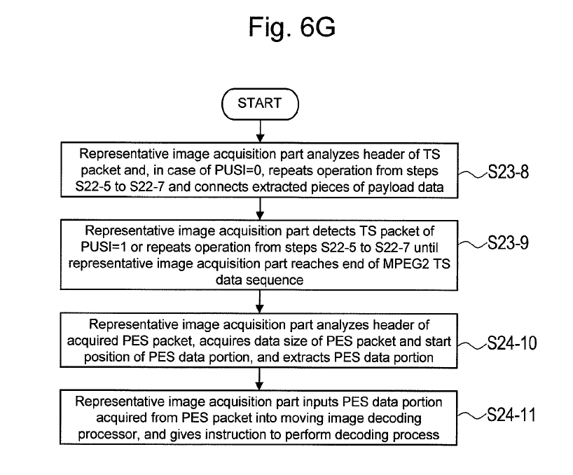

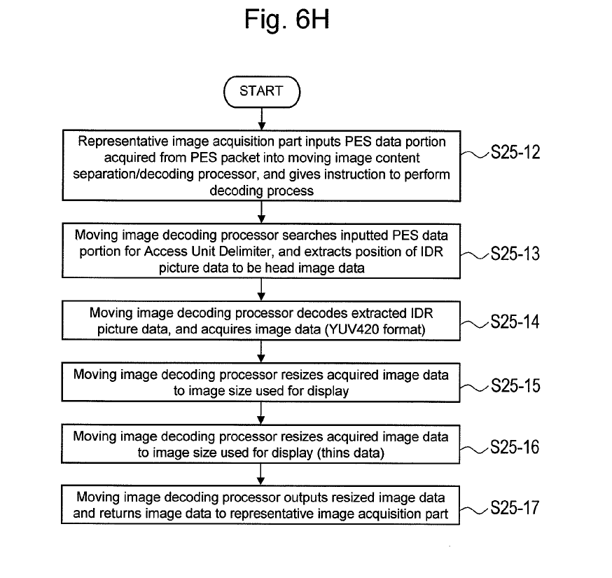

FIGS. 6A to 6E are views showing the outline of a representative (head) image data acquisition method, and FIGS. 6F to 6H are charts showing the flow of process of the representative (head) image data acquisition method.

FIG. 6A is a view showing a data configuration in the external storage unit 11. The data stored in the external storage unit 11, such as the SB1 file in an SD card (trade name) (in the case where the data is encrypted), is formed of a data sequence in which “header” and “encrypted data” are defined as one unit. A fixed data pattern is included at the position of the header. Moreover, a list of positions (offsets) of respective pieces of data in which the IDR pictures are included is written in the MOI file. Thus, from the start position of one piece of data and a corresponding one of the offsets, the start position of the next piece of the data can be calculated.

As shown in FIG. 6F, when the process is started (start), the representative image acquisition part 31 requests the external storage unit I/O interface part 41 to acquire the “head data” including the IDR picture in step S21-0. In step S21-1, the external storage unit I/O interface part 41 refers to the MOI file described above, and calculates a portion of “head data” from the offset of data sequence including IDR picture. In step S21-2, the external storage unit I/O interface part 41 extracts encrypted data on the basis of the calculated portion of “head data,” and decryption is performed by using the decryption processor 45. In step S21-3, the external storage unit I/O interface part 41 returns a decrypted data sequence (MPEG2 TS) to the representative image acquisition part 31 (the returned data is stored in the memory 25). Note that, when data not encrypted (MPEG2 TS data) is to be used, the processes of steps S21-2 and S21-3 are not performed, and the portion of “head data” stored in the memory card is returned to the representative image acquisition part 31 without making any change.

FIG. 6B is a view showing an example of the process of decryption, and is a view showing how the encrypted data is decrypted and thus the MPEG2 TS data sequence is created.

When the “representative data” is decrypted, the data sequence of MPEG2 TS format which is formed of multiple TS packets is restored. Each TS packet has the fixed length of 188 bytes. Thus, in some cases, video data does not fit into a single TS packet when the video data is to be stored. In such case, the video data is divided into multiple TS packets. Whether data included in the TS packet is a part of divided data or not can be judged by checking a “PUSI” flag included in the header of the TS packet. A packet of “PUSI=1” indicates that the packet includes the start position of divided data, and a packet of “PUSI=0” indicates that the packet includes a part of divided data in the middle (or at the end).

FIG. 6C is a view showing how the PES packet is acquired. When the PES packet is to be acquired from the aforementioned data sequence of MPEG2 TS, payloads in the data sequence of MEPG2 TS are connected, and thus the PES packet formed of a PES header and a data sequence of coded video data can be acquired.

FIG. 6D is a view showing how a PES data portion is acquired. As described above, the PES data portion includes the data sequence of coded video data. The data sequence of coded video data included in the PES packet is a data sequence in which the “access units (AU)” are connected. The access unit is one unit of coding, and each access unit corresponds to one piece of IDR picture data, or to one piece of P picture data. When the access units (AU) are connected, one PES packet includes multiple pieces of picture data. Here, if the PES packet includes a piece of IDR picture data, the piece of IDR picture data is always placed right after the PES header, and the piece of P picture data is placed after the piece of the IDR picture data. After the acquisition of the PES packet, the representative (head) image part analyzes the PES header, detects the head position of the data sequence, and acquires the access units including the video data.

Next, as shown in step S22-4, the representative image acquisition part 31 analyzes the headers of the TS packets included in the received MPEG2 TS data sequence, from the head position of the received MPEG2 TS data sequence, and searches for a packet of PUSI=1 (generally, the packet is at the head of the MPEG2 TS data sequence). In step S22-5, the representative image acquisition part 31 acquires the length of an adaptation field from the header of the found TS packet, and calculates the start position of a payload in the TS packet and the length of the payload. In step S22-6, the representative image acquisition part 31 uses the calculated payload start position and the payload length to extract payload data. In step S22-7, the representative image acquisition part 31 moves a reference position in the MPEG2 TS data sequence to the position of the next TS packet.

As shown in FIG. 6G in step S23-8, the representative image acquisition part 31 analyzes the header of the TS packet. In a case of PUSI=0, the representative image acquisition part 31 repeats the processes from steps S22-5 to S22-7, and connects the extracted pieces of payload data. In step S23-9, the representative image acquisition part 31 detects the TS packet of PUSI=1 or repeats the processes from steps S22-5 to S22-7 until the representative image acquisition part 31 reaches the end of MPEG2 TS data sequence. Note that, the connected payloads form the PES packet at the time point when the process of step S23-9 is completed. In step S24-10, the representative image acquisition part 31 analyzes the header of the acquired PES packet, acquires the data size of the PES packet and the start position of the PES header portion, and extracts the PES data portion. In step S24-11, the representative image acquisition part 31 inputs the PES data portion acquired from the PES packet into the moving image decoding processor 33, and gives an instruction to perform a decoding process.

FIG. 6E is a view showing how head image data is acquired. The access unit including an IDR picture is separated from the PES data portion shown in FIG. 6D. A single access unit includes image data corresponding to one frame (in case of both an access unit including an IDR picture and an access unit including a P picture). A fixed pattern called Access Unit Delimeter is provided at the start position of the access unit. Accordingly, the PES data portion can be divided into pieces of data by searching for this pattern. Next, the access unit including the IDR picture is decoded into image data (YUV420 format). The decoding is executed for each access unit, and thus the decoded image data (YUV420 format) can be acquired.

As shown in FIG. 6H, in step S25-12, the representative image acquisition part 31 inputs the PES data portion acquired from the PES packet into the moving image decoding processor 33, and gives the instruction to perform the decoding process. In step S25-13, the moving image decoding processor 33 searches the inputted PES data portion for the Access Unit Delimiter, and extracts the position of the IDR picture data to be the representative image data. In step S25-14, the moving image decoding processor 33 performs decoding of the extracted IDR picture data, and acquires the image data (YUV420 format). In step S25-15, the moving image decoding processor 33 resizes the acquired image data to an image size used for the display. In step S25-16, the moving image decoding processor 33 resizes the acquired image data to an image size used for display (thins the data). In step S25-17, the moving image decoding processor 33 outputs the resized image data and returns the image data to the representative image acquisition part 31. Hereafter, the representative image acquisition part 31 gives an instruction to output the image data to the display unit 3.

Note that, the preview reproduction processor 35 performs processes similar to the procedures from steps S22-4 to S25-12 described above. Thereafter, in steps S25-13 to S25-17, the preview reproduction processor 35 searches for Access Unit Delimiters of not only the access unit including the IDR picture data but also of other access units, and repeats the processes of separation and decoding, until the preview reproduction processor 35 reaches the end of the data.

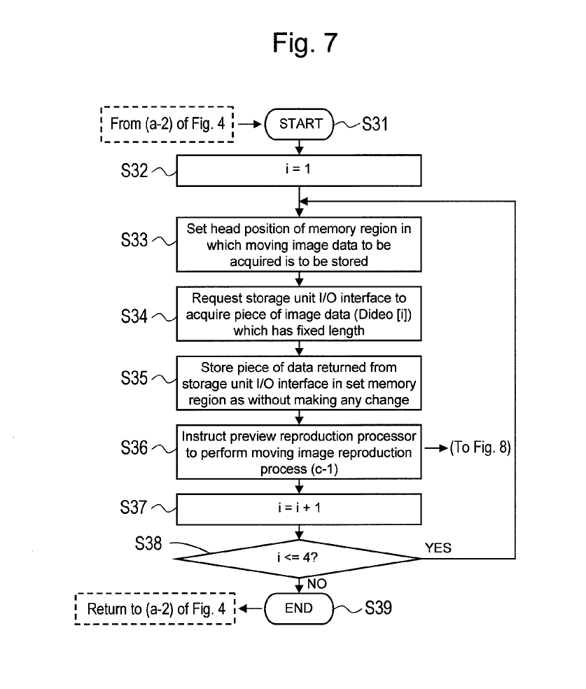

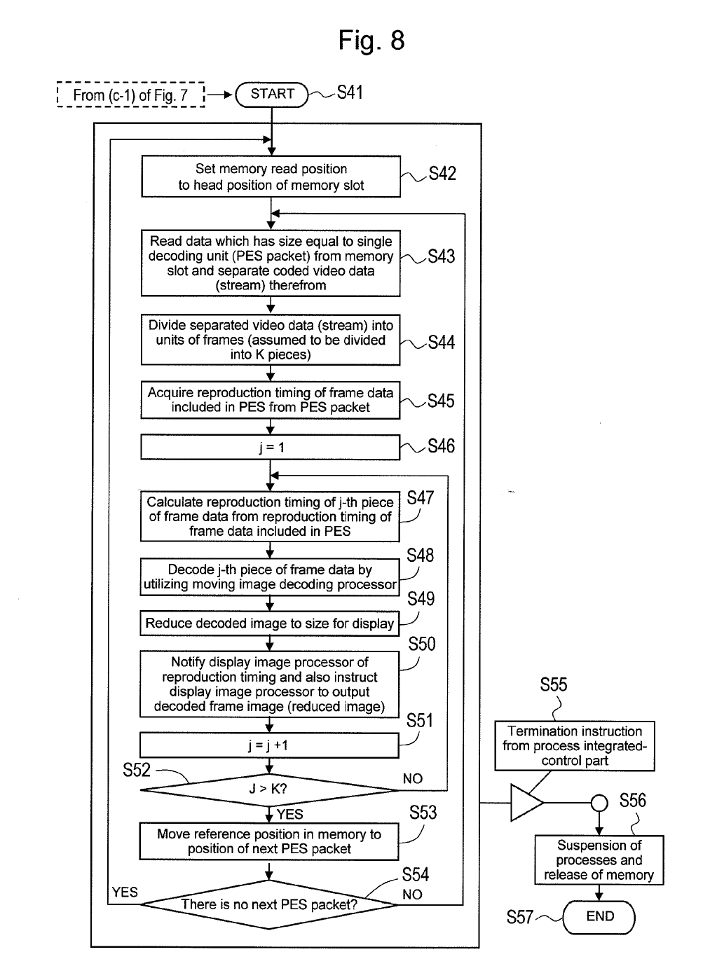

FIG. 7 is a chart showing a flow of process in the moving image data acquisition part 27. First, the moving image data acquisition part 27 starts the process in response to an instruction from the process integrated-control part 23 (step S31: START, a-2 of FIG. 4). Note that, a region in which the moving image data is to be stored is secured by the process integrated-control part 23 in advance. In step S33, the moving image data acquisition part 27 sets a head position of a memory region in which the moving image data to be acquired is to be stored. Each of the contents is associated with a head address of a corresponding storage destination memory region (memory slot) (see FIG. 10). In step S34, the moving image data acquisition part 27 requests the storage unit I/O interface 41 to acquire a piece of the moving image data (Video [i]) which has a fixed length. Here, unlike the case of step S13 of FIG. 5, the request is given of acquisition of a piece of the moving image data having a specified size (800 kB, for example). In step S35, the piece of data returned from the storage unit I/O interface is stored in the memory region set in step S33, without making any change. The data acquired here is not temporarily stored in a working memory or the like, and is directly written (transferred) to the corresponding memory slot. In step S36, the moving image data acquisition part 27 instructs the preview reproduction processor 35 to perform the moving image reproduction process, and the operation of the preview reproduction processor 35 is started when the writing of data to the memory region is completed. A preview reproduction process can be performed in parallel with the process of the moving image data acquisition part 27 and the process of the process integrated-control part 23 (the parallel operation can be achieved by utilizing a function provided by an operating system (OS)). When the process is completed, the moving image data acquisition part 27 returns the control to the process integrated-control part 23 (a-2 of step S5 of FIG. 4). The moving image data acquisition part 27 sets i=i+1 in step S37, and judges whether i≦4 or not in step S38. If NO, the process is terminated in step S39, and the flow returns to step S5. If YES, the flow returns to step S33, and the process continue to be performed.

FIG. 8 is a chart showing a flow of a process in the preview reproduction processor 35. The process is started by a notification from the moving image data acquisition part 27. First, the process is started in step S41 (START). In step S42, a memory read position is set to the head position of the memory slot. Next, in step S43, data which has a size equal to a single decoding unit (PES packet) is read from the memory slot and coded video data (stream) is separated therefrom. Since there is a case where one PES packet stores multiple pieces of frame data, the read data is further divided into units of frames.

In step S44, the separated video data (stream) is divided into units of frames (assumed to be divided into K pieces). The frame data decoding in this process is performed on a P picture for restoring image data by use of past pieces of the frame data which have been already decoded, in addition to the IDR picture. In the decoding of the P picture, a compensation process between frames such as motion compensation is performed. Thus, the amount of calculation is larger compared to that for the IDR picture the process for which is generally completed in a frame. In step S45, a reproduction timing of the frame data included in the PES is acquired from the PES packet.

In step S46, a reproduction timing of the j-th piece of the frame data is calculated from the reproduction timing of the frame data included in the PES. When K pieces of the frame data are included in the PES packet, all of the images of the K pieces of the data included in the PES packet are decoded before the next frame data is read, and the display of the images is performed. In step S48, the decoding process of the j-th piece of the frame data is performed by utilizing the moving image decoding processor 33. In step S49, the decoded image is reduced to the size for display. In step S50, the preview reproduction processor 35 notifies the display image processor 37 of the reproduction timing and also instructs the same to output the decoded frame image (reduced image). The display image processor 37 having received the instruction to output the frame image updates a preview display image and outputs the frame image to the display unit in accordance with the reproduction timing received together with the frame image. The preview reproduction processor 35 sets j=j+1 in step S51, and judges whether J>K or not in step S52. If YES, the flow proceeds to step S53, and the reference position in the memory is moved to the position of the next PES packet. Then, in step S54, the preview reproduction processor 35 judges whether there is the next PES packet or not. If YES, the flow returns to step S42. If NO, the flow returns to step S47.

Note that, when a termination instruction is received from the process integrated-control part 23 (step S55), interruption (a function of the OS is usable) is made. Here, all the processes are suspended and the memory 25 is released (step S56). Thereafter, the processes are terminated (step S57).

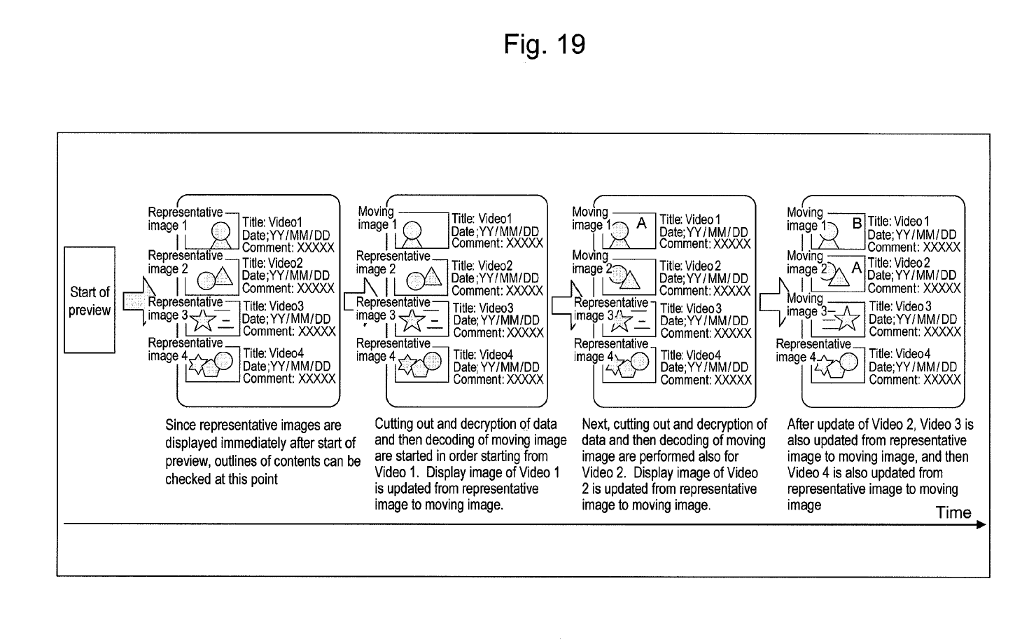

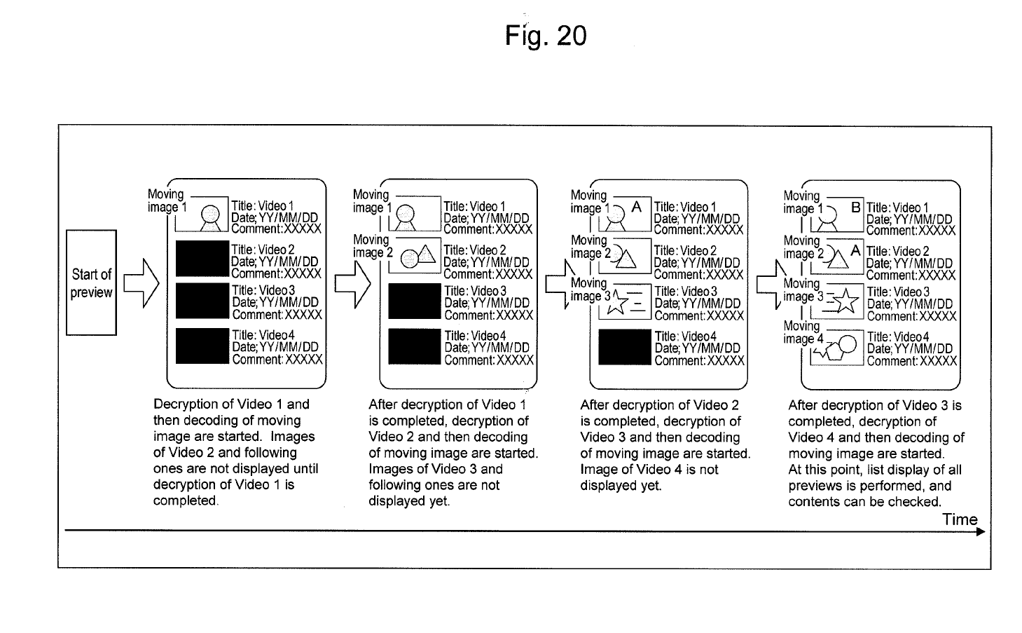

FIG. 19 is a view showing an example of a preview display screen of multiple moving images in the device of the embodiment which is capable of reproducing multiple moving image contents (FIG. 19 shows an example in which four moving images are displayed) on the basis of the processes described above. FIG. 19 is a view corresponding to FIG. 20. As shown in FIG. 19, when the instruction to start the preview is given, first, the decryption process of the moving image 1 (Video 1) is performed together with the display process of all the representative images of the respective Videos 1 to 4. The cutting out of data, decryption, and decoding of the moving image are performed continuously, in order starting from the Video 1. The display image of the Video 1 is updated from the representative image to the moving image. Then, the cutting out of data, decryption, and decoding of the moving image are performed for the Video 2 in a similar manner, and the display of the Video 2 is updated from the representative image display to the preview display. After the Video 2 is updated, the Video 3 is similarly updated from the representative image to the moving image. Thereafter, the Video 4 is also updated from the representative image display to the preview display. At this point, all (four) the previews (display of the representative images) are displayed in a list, and contents of all the moving images can be checked from the preview display. The display of the representative images is performed in a short time in a period before the state where the preview display can be made. This is advantageous compared to the case of FIG. 20 in that the user can know the contents of the moving images earlier.

Note that, in the embodiment, descriptions have been given of the example in which a single still image is used as the representative image. However, multiple still images may be used as the representative image. An expansion may be made in which, in the representative image acquisition part, the length of a piece of the moving image data to be processed is made large enough to include pieces of data corresponding to several frames, and the extracted pieces of data corresponding to several frames are displayed sequentially. Effects similar to the embodiment can be obtained from this expansion. In this case, the number of extracted frames is smaller than the number of frames in the moving image data.

Note that, in the embodiment, descriptions have been made while giving the mobile phone terminal as an example of the moving image display device. However, the invention is applicable to GUIs in other one-seg broadcast display devices, video recorders, digital television receivers, personal computers, and the like. Moreover, when the present invention is applied to a digital television receiver which has a display unit with high definition or to a personal computer which includes a high-speed CPU and a large-capacity memory, and the like and there is no need to reduce the image size, the reduction process for preview display may be omitted. Here, instead of performing preview display, an image may be displayed in an original image size.

Note that, there are the following cases of displaying multiple moving images A and B in parallel as moving images (previews). These cases are also included in the scope of the invention.

### Modified Example 1

### Representative Image is Substituted with Arbitrary Moving Image Identification Data

In this case, after a still image being one frame of the moving image A is displayed and before the display of the moving image (preview) of A is automatically started, a still image being one frame in the moving image B is displayed separately from the still image of the moving image A. Note that, each of the still images is preferably one frame at the head of the corresponding moving image, but may also be another frame. Instead of such a still image, a still image which is included in a moving image file (including streaming) separately from the one frame of the moving image or information other than the still image which characterizes the moving image (such as a file name) may be displayed. The representative image described above (including the still image described above), the still image included separately from the one frame of the moving image, and the information characterizing the moving image (such as a file name, including Video information described above) which are described above will be collectively called as moving image identification data. Each piece of the image identification data is associated with a corresponding piece of the moving image data, and enables identification of the corresponding piece of the moving image data.

### Modified Example 2

### Adjustment of Timings of Representative Image and Moving Image Display

The invention includes a case where display of a frame 1 (still image) of A is performed, the display of the frame 1 of A continues until a still image of B is displayed, and frames “2” and thereafter of A are displayed as the moving image (preview) after the still image of B is displayed. In other words, the respective timings of displaying the still images and the moving image (preview) can be adjusted as appropriate.

### Modified Example 3

### Displaying Representative Image and Moving Image Corresponding to Representative Image at Positions Different from Each Other

Moreover, a representative image (still image) and a moving image corresponding to the representative image may be displayed respectively at positions different from each other. This example includes a display method of displaying the moving image with the representative image being displayed, and a display method of stopping the display of the representative image and displaying the moving image.

Note that, in the examples described above, the descriptions are given by using the general stored moving image data as an example. However, the moving image data to be processed may be streaming data.

Furthermore, in the embodiment described above, the descriptions are given of the example in which the moving image data (Video data) is stored in the external storage unit 11 and is sent to the moving image data acquisition part 27 or the representative image acquisition part 31 via the storage unit I/O interface 41. However, the moving image data may be stored in a storage part (hard disk, memory, or the like) in the mobile phone terminal A.

Alternatively, the moving image data may be stored in a server or the like which is provided outside the mobile phone terminal A, instead of the external storage unit 11. In this case, a communication interface is used in place of the storage unit I/O interface 41. The communication interface is an interface which connects the moving image data acquisition part 27 and the representative image acquisition part 31 with a phone line or a network such as a wireless or wired LAN. The communication interface receives the moving image data from the network or the like, and sends the received moving image data to the moving image data acquisition part 27 and the representative image acquisition part 31.

Moreover, in the embodiment described above, the configuration and the like are not limited to those illustrated in the attached drawings, and may be appropriately changed within a scope in which the effects of the invention can be obtained. In addition, the invention can be carried out with appropriate changes being made within a scope of the object of the present invention.

Moreover, a program for implementing the functions described in the embodiment is recorded in a computer readable recording medium. Then, the program recorded in this recording medium is read by a computer system, and is executed to perform the processes of the parts. Note that, the “computer system” herein shall include an OS and hardware such as peripheral devices.

Moreover, if the “computer system” is one which utilizes the WWW system, the “computer system” shall have a homepage providing environment (or displaying environment).

Moreover, the “computer readable recording medium” refers to a transportable medium such as a flexible disk, a magneto-optical disc, a ROM, and a CD-ROM, as well as to a storage unit such as a hard disk incorporated in the computer system. Furthermore, the “computer readable recording medium” includes an object such as a communication line which dynamically holds the program for a short period when the program is transmitted via a communication line such as a phone line or a network such as the Internet, and also includes an object which holds the program for a certain period, such as a volatile memory in a computer system serving as a server or a client in this case. In addition, the program may be one which implements part of the functions described above. Moreover, the program may be one which implements the functions described above in cooperation with a program already stored in the computer system.

Furthermore, other modified examples of the embodiment are described below.

Before the preview display of the moving image A among multiple moving images is performed, the representative images such as the still images of the moving images A and B are displayed. Since the process of acquiring the representative images by the representative image acquisition part is fast, the displaying of the still images of A and B from a state where nothing is displayed is completed earlier than the displaying of the previews of A and B from the same state. When the preview display becomes possible, each sill image is substituted with display of a corresponding preview.

The present invention provides a moving image display device including: the process integrated-control part configured to perform integrated control of the process of reproducing multiple moving images in parallel and displaying the moving images on the display part; and the interface part, storage part, representative image acquisition part, and display image processor which operate based on instruction from the process integrated-control part, the interface part configured to acquire the moving image data, the storage part configured to temporarily store the moving image data acquired by the interface part, the representative image acquisition part configured to extract the representative image of the moving image data stored in the storage part, the display image processor configured to substitute the first still image with the moving image corresponding to the first still image after the first still image and the second still image being the representative images are displayed on the display part.

The processes described above are started upon receiving the instruction to perform the list display of multiple moving images from the operation part, for example. The moving image display device may be configured such that the moving image display device includes the preview reproduction processor configured to perform the image process of creating the preview data for the preview display of the moving images on the basis of the moving image data stored in the storage part, and upon receiving the preview data processed by the preview reproduction processor, the display image processor substitutes the representative image of a corresponding one of the moving images with the preview data.

Each of the representative images is preferably a still image representing the corresponding moving image or an image which requires no reference to any preceding or subsequent frame in the corresponding moving image.

Moreover, the following configuration is preferable. The moving image display device includes the memory configured to temporarily store the pieces of the moving image data in the slots provided respectively for the pieces of moving image data. The process integrated-control part causes the pieces of the moving image data written to the memory to be read, sequentially decoded, and then sent to the display image processor. It is preferable that the process integrated-control part monitors each slot to see whether a piece of the moving image data is stored, and if a piece of the moving image data is stored, and causes to start the reading of this piece of the moving image data.

The present invention may be a moving image display method, a program causing a computer to execute the moving image display method, and a computer readable recording medium storing the program. The program may be one acquired from a transmission medium such as the Internet.

### INDUSTRIAL APPLICATION

The present invention can be utilized in a moving image display device.

All the publication, patent, and patent application cited in the description are incorporated in the description as reference.

1.-10. (canceled)

11. A moving image display device comprising:
a process integrated-control part configured to perform integrated control of processes of reproducing a plurality of moving images in parallel and displaying the moving images on a display part; and
a storage part, a representative image acquisition part, and a display image processor which operate based on instructions from the process integrated-control part,
the storage part configured to store first moving image data and second moving image data which are pieces of moving image data,
the representative image acquisition part configured to extract or create still image data from the moving image data stored in the storage part,
the display image processor configured to cause the moving image data and the still image data to be displayed, wherein
when an instruction is given to perform list display of the moving image data, the representative image acquisition part extracts or creates first still image data from the first moving image data, and extracts or creates second still image data from the second moving image data, and
after causing the display part to display the first still image data and the second still image data, the display image processor causes the display part to automatically display moving images of the first moving image data and the second moving image data.

12. The moving image display device according to claim 11, wherein
the process integrated-control part instructs the representative image acquisition part to acquire a predetermined portion of the moving image data, and
the representative image acquisition part extracts or creates the still image data on the basis of a result obtained by decoding the predetermined portion.

13. The moving image display device according to claim 11, further comprising a decryption processor configured to decrypt encrypted moving image data, wherein
the moving image data is encrypted data, and
after the decryption processor decrypts a predetermined portion of the moving image data, the representative image acquisition part processes the decrypted predetermined portion of the moving image data and the decryption processor decrypts a portion of the moving image data other than the predetermined portion.

14. The moving image display device according to claim 11, wherein
the first still image data is data in one frame in the first moving image data, and
in displaying the moving image of the first moving image data, the display image processor causes the moving image to be displayed from the one frame.

15. The moving image display device according to claim 11, wherein
the first still image data is data in one frame in the first moving image data, and
in displaying the moving image of the first moving image data, the display image processor causes the moving image to be displayed from a frame subsequent to the one frame.

16. The moving image display device according to claim 11, wherein
the representative image acquisition part extracts or creates a plurality of pieces of still image data from the moving image data, and
in displaying the first still image data or the second still image data on the display part, the display image processor causes the plurality of pieces of still image data to be sequentially displayed.

17. The moving image display device according to claim 11, further comprising a preview reproduction processor configured to perform an image process of creating preview data for preview display of each of the moving images on the basis of the moving image data stored in the storage part, wherein
upon receiving the preview data processed by the preview reproduction processor, the display image processor substitutes the still image data of the corresponding moving image with the preview data.

18. The moving image display device according to claim 11, wherein each piece of the still image data is of a still image representing the corresponding moving image or is of an image of the moving image which requires no reference to any preceding or subsequent frame.

19. A moving image display method for reproducing first moving image data and second moving image data in parallel and displaying the first moving image data and the second moving image data on a display part, the method comprising:
a representative image acquisition step of extracting or creating still image data from moving image data; and
a display image processing step of displaying the moving image data and the still image data, wherein
when an instruction to perform list display of the moving image data is given, in the representative image acquisition step, first still image data is extracted or created from the first moving image data and second still image data is extracted or created from the second moving image data, and
in the display image processing step, the first still image data and the second still image data are displayed on the display part, and thereafter moving images of the first moving image data and the second moving image data are automatically displayed on the display part.
